(19) United States
(12) Patent Application Publication
(10) Pub. No.: US 2006/0010426 A1
(43) Pub. Date: Jan. 12, 2006

(54) System and method for generating optimized test cases using constraints based upon system requirements

(75) Inventors: William E. Lewis, Plano, TX (US); Michael Terkel, Dallas, TX (US)

Correspondence Address: CHALKER FLORES, LLP, 2711 LBJ FRWY, Suite 1036, DALLAS, TX, 75234, US

(73) Assignee: Smartware Technologies, Inc., Plano, TX (US)

(21) Appl. No.: 10/887,592

(22) Filed: Jul. 9, 2004

(51) Int. Cl. G06F 9/44

(52) U.S. Cl. 717/124

(57) ABSTRACT

The present invention provides a system, method and computer program for generating a final optimized test data set. An initial test data set, one or more data rules and one or more business rules are provided. The initial test data set is then modified using the one or more data rules. The modified test data set is optimized using an orthogonal array. The final optimized test data set is then generated by applying the one or more business rules to the optimized test data. The present invention can be implemented using a computer program embodied on a computer readable medium wherein each step is executed by one or more code segments. The system used to implement the present invention may include a data storage device, a processor and one or more input/output devices.

### PRIORITY CLAIM

This patent application is a U.S. non-provisional patent application of U.S. provisional patent application Ser. No. 60/486,085 filed on Jul. 10, 2003.

### TECHNICAL FIELD OF THE INVENTION

The present invention relates generally to the semi-automated and automated testing of software and, more particularly, to a system and method for generating a minimal number of optimized test sets for testing a software application or a system based on application or system requirements.

### BACKGROUND OF THE INVENTION

Newly developed software programs must be thoroughly tested in order to eliminate as many “bugs”, or errors, as soon as possible before the software is released for widespread public use. Having an accurate and thorough set of test cases is crucial to locate as many of these “bugs” or errors in the software as possible. However, there are many problems with conventional software development and testing which make it difficult to develop a set of test cases that fully and accurately test the software program or system that is being developed. The increased complexity of current software exasperates the problem. Moreover, miscommunication between the customer, system analyst, software designer or systems designer, the testers, the selection of the correct test cases, as well as not having the proper tools to develop optimum tests are amongst the problems faced today that make software testing more difficult and time consuming.

There are a few methods for testing software programs and a few methods for developing test cases currently in existence. A common method to test software is called “requirements-based testing”. With this approach, the software tester writes a suite of test cases based on the requirements that have been specified for the software application. The software tester then executes these application tests to verify the requirements. However, a common problem with this approach is that the requirements are generally not specific enough to write an accurate test suite. Moreover, since the interpretation of each of the requirements is subjective, the tests that could be written vary from tester to tester. As such, the end result of the testing may not accurately or thoroughly test an application or system.

Another common method for testing software is with test cases written based on “functional requirements”. Functional requirements are a detailed description of how an application should perform functionally and are based on general requirements. Good functional requirements are detailed enough to explain how a screen or window should look, what fields should be contained in the screen or window, and what values should be in each field. The software tester writes a set of test cases based on the functional requirements and then performs these tests on the application. A shortcoming of this approach is that the number of test combinations varies and can be very large. Since the amount of time necessary to fully and accurately test the software or system using all the possible testing combinations is most likely unavailable, only a fraction of the tests are actually created and executed. This leaves several combinations untested, thereby allowing the possibility that bugs or errors will remain undetected.

Yet another method of testing software is called “ad hoc” testing. With this testing method, the tester does not have a formal set of test cases but tests based upon the implementation of the software itself. Stated in another way, the software tester runs the software application and attempts to use the software application as it is intended to discover any bugs or errors while operating the software. However, the use and testing of software applications is very subjective and may be performed differently from one tester to another. With this approach, there are still several combinations of tests that may not be created and taken into consideration. Creating tests cases using this approach is the least productive since there is no formal documentation to validate the software or system behavior.

In an attempt to make the testing process faster and more accurate, many software testing companies employ automated testing tools commonly known as “capture replay” tools which perform automatic testing of a software application. Although these tools save software testers a great deal of time, they do not solve the common problem of what tests to run, i.e. the test data. The individual tester must program the capture replay tool to run the test using one of the methods mentioned above.

The problem with these methods is that none of them have a tool or technique that will produce an accurate set of tests to verify that all combinations or functions work correctly. For example, if one gave a requirements document to ten different testers and asked them to write test cases, it is almost certain that the testers will not write the same exact tests or develop the same exact automated scripts. The tests created relate directly to the experience, skill, time available to each tester, and how the tester feels on a particular day. As a result, there is a need for a process and method to address the drawbacks of the above-noted methods for testing software by providing a very user-friendly and accurate way of developing an optimal set of tests.

### SUMMARY OF THE INVENTION

The present invention addresses the drawbacks of the prior art by permitting a software tester to create an optimized and efficient set of test case data. The first step in the process requires the software tester to enter or import the Test Data, Data Rules, and Business Rules. Test data is derived from fields and values from a graphical user interface, parts of a network, system configurations, functional items, etc. and is usually based on the requirements, the functional specification, or the application interface itself. Data rules reflect the behavior of the Test Data and are used to constrain or modify the initial test data set. Business Rules reflect the behavior of the application or system. Both Data Rules and Business Rules are entered by the tester in a simple English prose format or native language of the tester. In the second step of the process, Data Rules are applied to the initial set of test data thus constraining or modifying the test data. In the third step of the process, the set of modified test data combinations is optimized by generating “pair-wise” values using orthogonal arrays to produce an optimized set of test case data. Since ‘Exhaustive Testing’ is unrealistic or impossible, Pair-wise tests allow the use of a much smaller subset of test conditions while providing a statistically valid means of testing all individual component state transitions. The final step is to apply Business rules to the optimized set of test case data in order to define the final test set.

The present invention provides a method for generating a final optimized test data set using an initial test data set, one or more data rules and one or more business rules. The initial test data set is modified using the one or more data rules. The modified test data set is then optimized using an orthogonal array. The final optimized test data set is generated by applying the one or more business rules to the optimized test data. The present invention can be implemented using a computer program embodied on a computer readable medium wherein each step is executed by one or more code segments. Such a computer program can be a plug in or part of a developer's tool kit.

In addition, the present invention provides a method for generating a final optimized test data set using an initial test data set. The initial test data set is modified using a first set of constraints. The modified test data set is the optimized using an orthogonal array. The final optimized test data set is generated by applying a second set of constraints to the optimized test data. The first set of constraints may include one or more data rules and the second set of constraints may include one or more business rules. The present invention can be implemented using a computer program embodied on a computer readable medium wherein each step is executed by one or more code segments. Such a computer program can be a plug in or part of a developer's tool kit.

Moreover, the present invention provides a system that includes a data storage device, a processor and one or more input/output devices. The data storage device has an initial test data set, one or more data rules and one or more business rules stored therein. The processor is communicably coupled to the data storage device and modifies the initial test data set using the one or more data rules, optimizes the modified test data set using an orthogonal array and generates the final optimized test data set by applying the one or more business rules to the optimized test data. The one or more input/output devices are communicably coupled to the processor. The processor can be part of a computer, a a server or a workstation. As a result, the data storage device, processor and input/output devices can be remotely located and communicate with one another via a network.

Other features and advantages of the present invention will be apparent to those of ordinary skill in the art upon reference to the following detailed description taken in conjunction with the accompanying drawings.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is an overall diagram illustrating various systems implementing the present invention;

FIG. 2 is a flow diagram of a method to generate optimized test cases in accordance with one embodiment of the present invention;

FIG. 3 is a flow diagram of a method to generate optimized test cases in accordance with another embodiment of the present invention;

FIG. 4 is a flow diagram of the process steps to generate optimized test cases which are constrained based on Data Rules and system or application requirements (Business Rules) in accordance with another embodiment of the present invention; and

FIG. 5 is a flow diagram of an example in accordance of one embodiment of the present invention.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and do not delimit the scope of the invention.

The present invention addresses the drawbacks of the prior art by permitting a software tester to create an optimized and efficient set of test case data. The first step in the process requires the software tester to enter or import the Test Data, Data Rules, and Business Rules. Test data is derived from fields and values from a graphical user interface, parts of a network, system configurations, functional items, etc. and is usually based on the requirements, the functional specification, or the application interface itself. Data rules reflect the behavior of the Test Data and are used to constrain or modify the initial test data set. Business Rules reflect the behavior of the application or system. Both Data Rules and Business Rules are entered by the tester in a simple English prose format or native language of the tester. In the second step of the process, Data Rules are applied to the initial set of test data thus constraining or modifying the test data. In the third step of the process, the set of modified test data combinations is optimized by generating “pair-wise” values using orthogonal arrays to produce an optimized set of test case data. Since ‘Exhaustive Testing’ is unrealistic or impossible, Pair-wise tests allow the use of a much smaller subset of test conditions while providing a statistically valid means of testing all individual component state transitions. The final step is to apply Business rules to the optimized set of test case data in order to define the final test set.

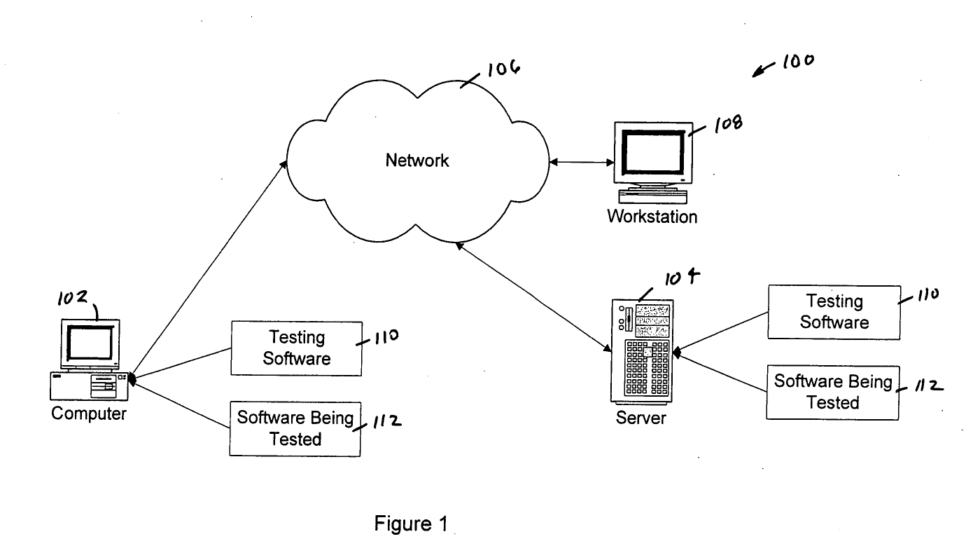

FIG. 1 is an overall diagram illustrating various systems 100 implementing the present invention. The present invention can be implemented solely on a single computer 102, on a computer communicably coupled to a server computer 104 via a network 106 or on a workstation 108 communicably coupled to a server computer 104 via a network 106. Other implementations are also possible. The computer 102 can be any type of commonly available computing system, which typically includes one or more input/output devices (e.g., a display monitor, keyboard, mouse, etc.) and one or more data storage devices (e.g., fixed disk drive, floppy disk, optical disk drive, etc.). Similarly, the workstation 108 can be any type of commonly available computing system, which typically includes a display monitor, keyboard and mouse. The computer 102 and workstation 108 may also have various peripherals attached to them either directly or through the network 106, such as a printer, scanner or other input/output devices. Likewise, the server 104 can be any type of commonly available computing system used for data management and storage, which typically includes a display monitor, keyboard, mouse, various fixed disk drives, floppy disk and/or optical disk drive. The computer 102, workstation 108 and server 104 can use any standard operating system, such as Microsoft Windows® 98, Windows® NT, Windows® 2000, Windows® XP, etc. The network 106 can be a local, intranet or wide area network, such as the Internet. The computers 102, 104, 108 can be communicably coupled to the network via a serial modem and a telephone line, DSL connection, cable, satellite, etc. The testing software 110 of the present invention can be installed on the computer 102 or server computer 104 and may be run remotely by the workstation 108. In addition, the software being tested 112 can be located on the computer 102 or the server computer 104.

In addition to generating optimized test case data, the present invention provides the following functionality: provides a viewable, expandable tree interface to view “test sets” using a graphical user interface; generates test input data with data rules; automatically generates positive or negative test sets; stores test data in a relational database; inputs parameterized or non-parameterized test data; reverse engineers parameterized input test data to eliminate duplicates; exports test results to EXCEL® in spreadsheet form which can then be input in to automated capture/replay testing tools. A business rule versus test case data grid cross-references business rules with test cases in a matrix format. The data grid also indicates whether certain test case data may be missing. Full bi-directionality from business rules to test cases is provided, i.e. forward and backward traceability. The test generating method can be applied to numerous computer and non-computer testing environments.

Computer environment examples to which the invention can be applied includes (but are not limited to):
Function testing—A black-box testing type geared to validate the system functional requirements of an application; covering all combined parts of a system.
GUI or navigation testing—Tests the GUI interface and interactions of an application such as drop down lists, combo boxes, and windows.
Stress Testing—Tests an application under heavy loads, such as testing of a Web site under a range of diverse work loads to determine at what point the system's response time degrades or fails.
Install/Uninstall testing—Tests the full, partial, or upgrade install/uninstall processes on various system configurations.
Interoperability testing—Tests the ability of different systems to communicate and exchange data, ex. running software and exchanging data in a heterogeneous network made up of several different LANs with different platforms.
Range Testing—Tests for each input in the range over which the system behavior should perform.
Configuration or compatibility testing—Tests how well software performs in a particular hardware/software/operating system environment.
Portability testing—Tests the ability to move source code level among computers from different vendors and of different architectures.
Network testing—The testing of telecommunication, LAN, WAN or wireless networks.
Object-oriented testing—White-box testing of the class interface or specification to assure that the class has been fully exercised and testing of message interactions.
Positive and Negative Testing—Tests all positive and negative inputs in an appropriate balance
Ad-hoc testing—A creative, informal type of software testing that is not based upon formal test plans or requirements. In this type of testing the tester uses his/her intuition in using the application under test to find defects.
Unit Testing—Testing particular functions or modules. Typically this is performed by programmers and not testers as it requires a detailed knowledge of the internal program design and code.
Regression testing—Re-testing of the software after fixes or modifications to the code or its environment have been made.

The present invention generates a minimal number of optimized pair-wise set of tests by using orthogonal Latin squares which maps value transitions. The software test generating system has a “best fit” algorithm to match input test data to the optimum Latin square. This invention can handle non-symmetric input test data. Applying Data Rules, optimizing the data, and applying Business rules further constrains the test data to represent the expected behavior of the target application or system.

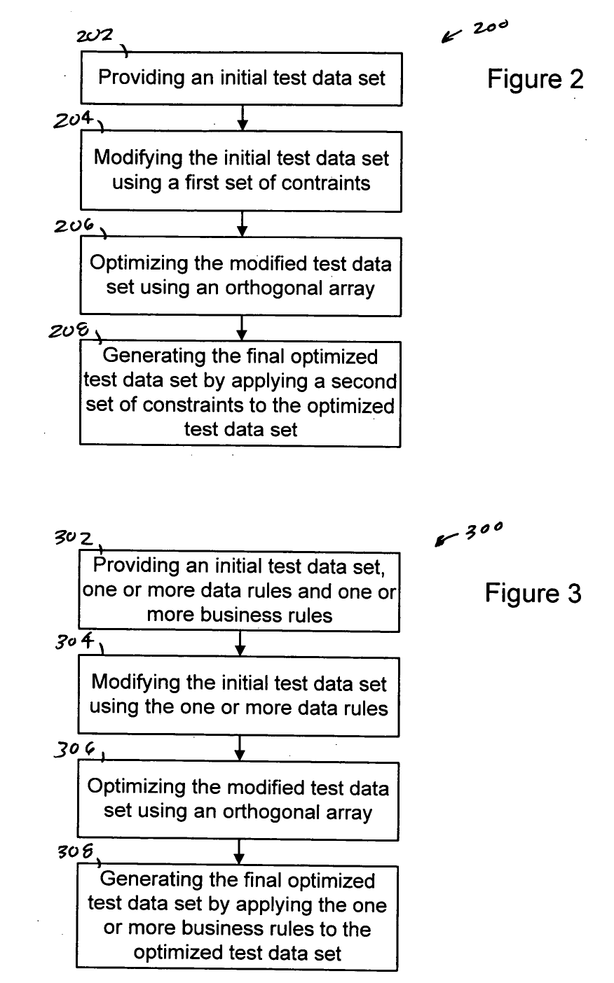

Now referring to FIG. 2, a flow diagram of a method 200 to generate optimized test cases in accordance with one embodiment of the present invention is shown. An initial test data set is provided in block 202. The initial test data set is modified using a first set of constraints in block 204. The modified test data set is the optimized using an orthogonal array in block 206. The final optimized test data set is generated by applying a second set of constraints to the optimized test data in block 208. The first set of constraints may include one or more data rules and the second set of constraints may include one or more business rules. The present invention can be implemented using a computer program embodied on a computer readable medium wherein each step is executed by one or more code segments. Such a computer program can be a plug in or part of a developer's tool kit.

Referring now to FIG. 3, a flow diagram of a method 300 to generate optimized test cases in accordance with one embodiment of the present invention is shown. An initial test data set, one or more data rules and one or more business rules are provided in block 302. The initial test data set is modified using the one or more data rules in block 304. The modified test data set is then optimized using an orthogonal array in block 306. The final optimized test data set is generated by applying the one or more business rules to the optimized test data in block 308. The present invention can be implemented using a computer program embodied on a computer readable medium wherein each step is executed by one or more code segments. Such a computer program can be a plug in or part of a developer's tool kit.

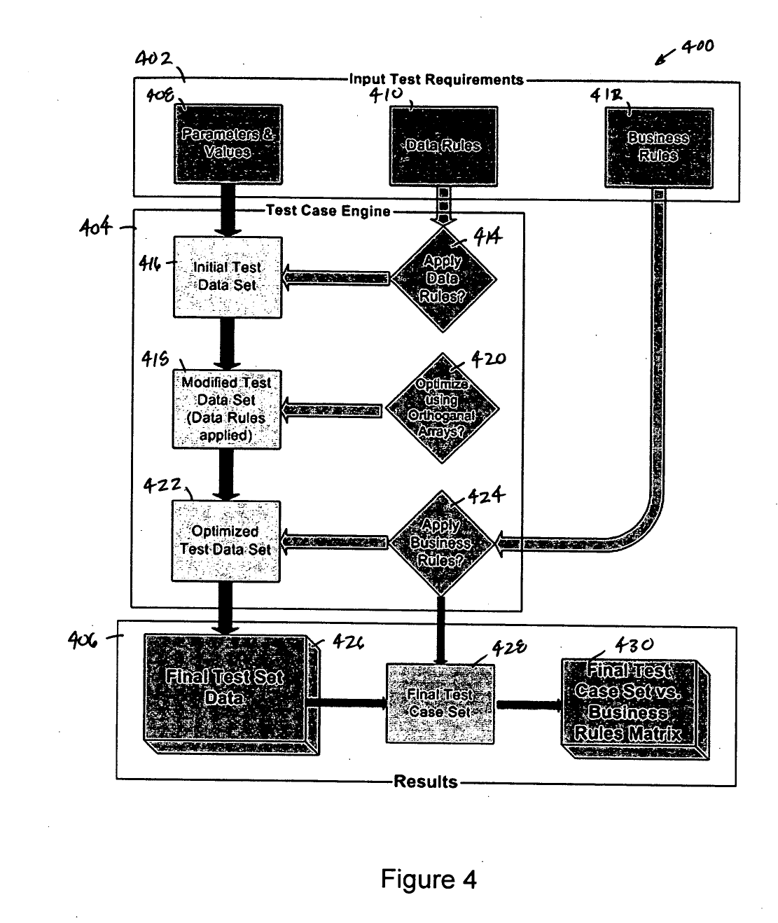

An overview of the process flow 400 to optimize the test input is illustrated in FIG. 4. The process includes input test requirements 402, a test case engine 404 and results 406. The test input data or requirements 402 consist of a 2-dimensional grid of parameters (columns) and values (rows) (collectively 408), Data Rules 410, and Business Rules 412. If the data rules are to be applied, as determined in decision block 414, the present invention first applies Data Rules 410 to the 2-dimensional grid of parameters and values (initial test data set 416), resulting in a modified 2-dimensional grid of parameters and values, or test data (modified test data set 418). If the modified test data set 418 is to be optimized, as determined in decision block 420, the modified test data 418 is then matched to an orthogonal array and a pair-wise optimized test data set is generated in block 422. If business rules 412 are to be applied to the optimized test data set 422, as determined in decision block 424, the business rules 412 are then applied to the optimized test set 422 to constrain the test set to automatically reflect the positive and negative behavior of the system or application under test and produce the final test set data 426. The business rules 412 can then be applied to the final test case set 428 to produce a matrix 430 of the final test case set 428 versus the business rules 412.

There are two types of business rules 412 (or constraints): Exclude and Require. An exclude business rule is a condition only. Each exclude business rule condition is applied to each row of the optimized test set that was previously created and will remove that row when one or more exclude rules is true within the pair-wise optimized test set. A Require business rule is a condition (if), action (then), and optional otherwise action (else). Each Require business rule (or constraint) is applied to each row of the optimized test set. If the business rule condition is true then the business rule action is applied to the test row data. If the business rule condition is false and there is an otherwise action, the otherwise action is applied to the test row data.

The processes of the present invention will now be described in more detail.

Step 1: Input the Test Data. The first step in generating an optimized set of test cases is to enter test data into a database. Test data is any combination of parameters and values that is required for a test. One example of test data can be that of an Interoperability Test where Operating System, RAM, CPU Speed, and Database are the test parameters. Each of these parameters has a set of values that is specific to that parameter. For example, the Operating System could be Windows NT, 2000 and XP. The RAM parameter might have 256MB, 512MB and 1Gig as values. The CPU Speed parameter might have the values Pentium II, Pentium III, and Pentium 4. The Database parameter might have values such as Oracle, SQL, and Access. These combinations of parameters and values define the test data. This data is entered into a database in the form of Columns and Rows. The Column header is the parameter. The data in the column under a specified parameter is the value. For a specific test, at least 2 parameters with at least 2 values each are required. Alternatively, if test data already exists in an Excel Spreadsheet or other table format, it can be imported directly into the testing system. During the input process duplicate values for a parameter are eliminated.

Step 2: Input the Data and/or Business Rules. There are two types of rules that can be used to determine the final set of test cases. Data rules manipulate the test data before optimization using orthogonal arrays. Business rules manipulate the optimized test data after the pair-wise combinations have been determined. Each rule type (expression) is limited to the parameters and values that are entered in step 1 of this method. Data Rules and Business Rules are independent of each other and are optional.

All examples below for the Data and Exclude Business Rules are based upon the following input test data table:

| State | Tax Rate | Date | Scale |
|---|---|---|---|
| Texas | .10 | Jan. 1, 2004 | 1 |
| Alabama | .20 | Jan. 2, 2004 | 5 |
| Florida | .30 | Jan. 3, 2004 | 10 |
| California | .40 | Jan. 4, 2004 | 25 |
| | .50 | | 50 |
| | .60 | | 75 |
| | .70 | | 100 |

Data Rules are entered into the testing system in the following format:

Condition Based Data Rules

| | | | | | | | |
|---|---|---|---|---|---|---|---|
| If | a | One | Equals | One or | Parameter | Equals | Value1, |
| | | Parameter | | more | | | Value2, |
| | | | | values: | | | . . . Vn |
| | | | | Value1, | | | |
| | | | | Value2, | | | |
| | | | | , . . . , | | | |
| | | | | Vn | | | |
| When | an | | is equal to | | | is equal to | |
| Whenever | the | | is set to | | | is set to | |
| | | | is | | | is | |
| | | | is (=) | | | is (=) | |
| | | | must be | | | must be | |
| | | | will be | | | will be | |
| | | | equals | | | equals | |
| | | | is not equal to | | | is not equal to | |
| | | | is not equal to | | | is not equal to | |
| | | | is not set to | | | is not set to | |
| | | | shall be | | | shall be | |
| | | | | * | | | |

Iteration Based Data Rules

| | | | | | | | | |
|---|---|---|---|---|---|---|---|---|
| (Same | — | — | — | — | For | Parameter | equals | X, Y by Z |
| Syntax as | | | | | | | | |
| Above) | | | | | | | | |
| | | | | * | | Parameter | equals | Date |
| | | | | | | | | formats, |
| | | | | | | | | Date |
| | | | | | | | | Ranges |
| | | | | * | | Parameter | equals | Alpha |
| | | | | | | | | formats |
| | | | | * | | Parameter | equals | Alpha- |
| | | | | | | | | numeric |
| | | | | | | | | formats |

(* = wild card or unconditional, e.g., no matter what the condition is)

The parameters and values must exist in the raw test data. The testing system allows the Data rule type to be entered in simple English prose or native language of the tester. Each Data rule is stored in the database as a string and is associated with the raw test data for a particular test.

The following examples illustrate the use of Condition-Based Rules.

### Example 1

Condition: If ‘Tax Rate’ is 0.10, 0.30, 0.50

Action: ‘State’ will be Texas, Alabama, Florida, California

Result: If the condition is true, the State parameter will be set to Texas and Alabama and Florida and California.

### Example 2

Condition: When the ‘Tax Rate’ is 0.10

Action: ‘State’ will be Texas

Result: If the condition is true, the State parameter will be set to Texas.

The following examples illustrate the use of Iteration-Based Rules.

### Example 1

Condition: If ‘State’ is Texas

Action: For ‘Tax Rate’=0.10, 1.0 by 0.1

Result: If the condition is true, the Tax Rate parameter will be set to the values 0.1, 0.2, 0.3, 0.4, 0.5, 0.6, 0.7, 0.8, 0.9, 1.0

### Example 2

Condition: *

Action: For ‘Tax Rate’=0, −10, by −1

Result: The Tax Rate parameter will unconditionally will be set to the values 0, −1, −2, −3, −4, −5, −6, −7, −8, −9, −10

### Example 3

Condition: *

Action: ‘Date’=Date/Mar. 12, 2004 to Dec. 25, 2004/dd:mm:yy

Result: The Date parameter will unconditionally have the dates from Mar. 12, 2004 to Dec. 25, 2005 in dd/mm/yy format.

### Example 4

Condition: *

Action: ‘Date’=Date/Mar. 12, 2004 to Dec. 25, 2004/dd:mm:yyyy

Result: The Date parameter will unconditionally will be set to the dates from Mar. 12, 2004 to Dec. 25, 2005 in dd/mm/yyyy format

### Example 5

Condition: *

Action: ‘Rate’=Alpha/1-8/Cap(1)/10

Result: The Rate parameter will unconditionally will be set to 10 random alpha values of character length 1 to 8 with the first character capitalized.

### Example 6

Condition: *

Action: ‘Rate’=AlphaNum/1 to 100/nn.n/Num(last)/15

Result: The Rate parameter will unconditionally will be set to 15 random alphanumeric values form one to one hundred with one decimal point, first character alpha and the last character numeric.

Business Rules consist of two types: Exclude or Require statements. An Exclude statement is a conditional expression which can be entered into the testing system in the following format:

Exclude Conditional Expression

| | | 1 | 2 | 3 | 4 | 5 | 6 | |
|---|---|---|---|---|---|---|---|---|
| Exclude | if | ( | One | equals | One Value | ) | and | Optional repetition of |
| | | | Parameter | | | | | columns 1 through 6 |
| | when | | | is equal to | | | , | Optional repetition of |
| | | | | | | | | columns 1 through 6 |
| | whenever | | | is not equal to | | | or | Optional repetition of |
| | | | | | | | | columns 1 through 6 |
| | | | | is not set to | | | | Optional repetition of |
| | | | | | | | | columns 1 through 6 |
| | | | | is not | | | | Optional repetition of |
| | | | | | | | | columns 1 through 6 |
| | | | | is set to | | | | Optional repetition of |
| | | | | | | | | columns 1 through 6 |
| | | | Calcu(Math | is less than or | Calcu(Math | | | Optional repetition of |
| | | | Expression) | equal to | Expression) | | | columns 1 through 6 |
| | | | | is less or equal to | | | | Optional repetition of |
| | | | | | | | | columns 1 through 6 |
| | | | | is less than | | | | Optional repetition of |
| | | | | | | | | columns 1 through 6 |
| | | | | is greater than or | | | | Optional repetition of |
| | | | | equal to | | | | columns 1 through 6 |
| | | | | is greater or equal | | | | Optional repetition of |
| | | | | to | | | | columns 1 through 6 |
| | | | | is | | | | Optional repetition of |
| | | | | | | | | columns 1 through 6 |
| | | | | is (=) | | | | Optional repetition of |
| | | | | | | | | columns 1 through 6 |
| | | | | is less than or | | | | Optional repetition of |
| | | | | equal (<=) | | | | columns 1 through 6 |
| | | | | is less than (<) | | | | Optional repetition of |
| | | | | | | | | columns 1 through 6 |
| | | | | is greater or equal | | | | Optional repetition of |
| | | | | (>=) | | | | columns 1 through 6 |
| | | | | greater than (>) | | | | Optional repetition of |
| | | | | | | | | columns 1 through 6 |
| | | | | must be | | | | Optional repetition of |
| | | | | | | | | columns 1 through 6 |
| | | | | will be | | | | Optional repetition of |
| | | | | | | | | columns 1 through 6 |
| | | | | shall be | | | | Optional repetition of |
| | | | | | | | | columns 1 through 6 |
| | | | | not | | | | Optional repetition of |
| | | | | | | | | columns 1 through 6 |
| | | | | * | | | | Optional repetition of |
| | | | | | | | | columns 1 through 6 |

Notes:
1. “*” = wild card or unconditional, e.g. no matter what the condition is.
2. “,” is treated as an “and”.
3. Calcu function is any mathematical expression with the multiply (*), divide (\), add (+), subtract (−) and exponent (\hat{ }) operands. A parenthesis can be used to clarify a mathematical expression.

The Parameters and values used in the expression should be parameters which exist in the test data. The testing system allows this rule type to be entered in simple English prose or native language of the tester. Each rule is stored in the database as a string and is associated with the raw test data for a particular test.

The following examples illustrate the use of Exclude Business Rules.

### Example 1

Condition: If ‘State’ is Texas

Result: If the condition is true for any row in the optimized test set, that row will be deleted.

### Example 2

Condition: When ‘State’ is Texas or (‘Rate’ equals 0.10 and ‘Capitol’ is Austin)

Result: If the compound condition is true for any row in the optimized test set, that row will be deleted.

### Example 3

Condition: Whenever ‘State’ is Texas or (‘Rate’ equals 0.10 and ‘Capitol’ is Austin)

Result: If the compound condition is true for any row in the optimized test set, that row will be deleted.

### Example 4

Condition: If ‘State’ is Texas or (‘Rate’ equals 0.10, ‘Capitol’ is Austin)

Result: If the compound condition is true for any row in the optimized test set, that row will be deleted.

### Example 5

Condition: *

Result: Deletes all rows in the optimized test set.

### Example 6

Condition: If ‘Rate’ is less than or equal to 100 and ‘Capitol’ is Austin)

Result: If the compound condition is true for any row in the optimized test set, that row will be deleted.

### Example 7

Condition: If ‘Rate’ is less than Calcu(‘Scale’ * 15)

Result: For an optimized row, the mathematical expression within the function called Calcu is calculated. If the Rate parameter is less than the calculated mathematical result row will be deleted.

### Example 8

Condition: If ‘Rate’ is less than Calcu(‘Scale’ * 15)

Result: For an optimized row, the mathematical expression within the function called Calcu is calculated. If the Rate parameter is less than the calculated mathematical result the row will be deleted.

### Example 9

Condition: If ‘Rate’ is less than Calcu(‘Scale’ * 15) and ‘State’ is Texas

Result: For an optimized row, the mathematical expression within the function called Calcu is calculated. If the Rate parameter is less than the calculated mathematical result and the State parameter is Texas the row will be deleted.

### Example 10

Condition: If Calcu(‘Rate’ * 70)>=Calcu(‘Scale’ * 15) and ‘State’ is Texas

Result: For an optimized row, the mathematical expression within the functions called Calcu is calculated. If the result of the first calculation is greater or equal to the second calculation and the State is Texas the row will be deleted.

A rule that is ‘Required’ is a conditional expression that must have an action statement and optionally an otherwise statement. This type of expression follows the if, then, else format. A ‘Require’ business rule is entered into the testing system with the following format:

All examples below for the Require Business Rules are based upon the following input test data table:

TABLE B
Sample Input test data

| Operating | | | | | Value | Maximum |
|---|---|---|---|---|---|---|
| System | Database | RAM | CPU | Price | Factor | Funds |
| Windows | Oracle | 128 | Pentium II | 1000 | 1 | 2000 |
| NT | | | | | | |
| Windows 95 | Access | 256 | Pentium | 2500 | 5 | 3000 |
| | | | III | | | |
| Windows VP | SQL | 500 | Pentium | 3500 | 10 | 5000 |
| | | | IV | | | |
| Windows 98 | Sybase | 1000 | | | 25 | 7000 |
| Windows | | 5000 | | | 50 | 10000 |
| 2000 | | | | | | |

Require Conditional Expression

| | 1 | 2 | 3 | 4 | 5 | 6 | | |
|---|---|---|---|---|---|---|---|---|
| Require | if | ( | One | equals | One Value | ) | and | Optional repetition of |
| | | | Parameter | | | | | columns 1 through 6 |
| | when | | Calcu(Math | is equal to | Calcu(Math | | , | Optional repetition of |
| | | | Expression) | | Expression) | | | columns 1 through 6 |
| | whenever | | | is not equal to | | | or | Optional repetition of |
| | | | | | | | | columns 1 through 6 |
| | | | | is not set to | | | | Optional repetition of |
| | | | | | | | | columns 1 through 6 |
| | | | | is not | | | | Optional repetition of |
| | | | | | | | | columns 1 through 6 |
| | | | | is set to | | | | Optional repetition of |
| | | | | | | | | columns 1 through 6 |
| | | | | is less than or equal to | | | | Optional repetition of |
| | | | | | | | | columns 1 through 6 |
| | | | | is less or equal to | | | | Optional repetition of |
| | | | | | | | | columns 1 through 6 |
| | | | | is less than | | | | Optional repetition of |
| | | | | | | | | columns 1 through 6 |
| | | | | is greater than or equal | | | | Optional repetition of |
| | | | | to | | | | columns 1 through 6 |
| | | | | is greater or equal to | | | | Optional repetition of |
| | | | | | | | | columns 1 through 6 |
| | | | | is | | | | Optional repetition of |
| | | | | | | | | columns 1 through 6 |
| | | | | is (=) | | | | Optional repetition of |
| | | | | | | | | columns 1 through 6 |
| | | | | is less than or equal | | | | Optional repetition of |
| | | | | (<=) | | | | columns 1 through 6 |
| | | | | is less than (<) | | | | Optional repetition of |
| | | | | | | | | columns 1 through 6 |
| | | | | is greater or equal (>=) | | | | Optional repetition of |
| | | | | | | | | columns 1 through 6 |
| | | | | greater than (>) | | | | Optional repetition of |
| | | | | | | | | columns 1 through 6 |
| | | | | must be | | | | Optional repetition of |
| | | | | | | | | columns 1 through 6 |
| | | | | will be | | | | Optional repetition of |
| | | | | | | | | columns 1 through 6 |
| | | | | shall be | | | | Optional repetition of |
| | | | | | | | | columns 1 through 6 |
| | | | | not | | | | Optional repetition of |
| | | | | | | | | columns 1 through 6 |
| | | | | * | | | | Optional repetition of |
| | | | | | | | | columns 1 through 6 |

Require Action

| 1 | 2 | 3 | 4 | |
|---|---|---|---|---|
| One Parameter | equals | One Value | and | Optional repetition of |
| | | | | columns 1 through 4 |
| | is equal to | Calcu(Math | , | Optional repetition of |
| | | Expression) | | columns 1 through 4 |
| | is not equal to | | | Optional repetition of |
| | | | | columns 1 through 4 |
| | is not set to | | | Optional repetition of |
| | | | | columns 1 through 4 |
| | is not | | | Optional repetition of |
| | | | | columns 1 through 4 |
| | is set to | | | Optional repetition of |
| | | | | columns 1 through 4 |
| | is less than or equal to | | | Optional repetition of |
| | | | | columns 1 through 4 |
| | is less or equal to | | | Optional repetition of |
| | | | | columns 1 through 4 |
| | is less than | | | Optional repetition of |
| | | | | columns 1 through 4 |
| | is greater than or equal to | | | Optional repetition of |
| | | | | columns 1 through 4 |
| | is greater or equal to | | | Optional repetition of |
| | | | | columns 1 through 4 |
| | is | | | Optional repetition of |
| | | | | columns 1 through 4 |
| | is (=) | | | Optional repetition of |
| | | | | columns 1 through 4 |
| | is less than or equal (<=) | | | Optional repetition of |
| | | | | columns 1 through 4 |
| | is less than (<) | | | Optional repetition of |
| | | | | columns 1 through 4 |
| | is greater or equal (>=) | | | Optional repetition of |
| | | | | columns 1 through 4 |
| | greater than (>) | | | Optional repetition of |
| | | | | columns 1 through 4 |
| | must be | | | Optional repetition of |
| | | | | columns 1 through 4 |
| | will be | | | Optional repetition of |
| | | | | columns 1 through 4 |
| | shall be | | | Optional repetition of |
| | | | | columns 1 through 4 |
| | not | | | Optional repetition of |
| | | | | columns 1 through 4 |
| “Expected | | | | Optional repetition of |
| Result” | | | | columns 1 through 4 |

Notes:
1. “Expected Result” is a fixed parameter name that is automatically created for every business rule and can be used in a require business rule to define the expected result from the optimized row test data.
2. “,” is treated as an “and”
3. The Calcu function is any mathematical expression with the multiply (*), divide (\), add (+), subtract (−) and exponent (\hat{ }) operands. A parenthesis can be used to clarify a mathematical expression.

Otherwise Action (If the Condition Is False And the Otherwise Is Specified)

| 1 | 2 | 3 | 4 | |
|---|---|---|---|---|
| One Parameter | Equals | One Value | and | Optional repetition of |
| | | | | columns 1 through 4 |
| | is equal to | Calcu(Math | , | Optional repetition of |
| | | Expression) | | columns 1 through 4 |
| | is not | | | Optional repetition of |
| | equal to | | | columns 1 through 4 |
| | is not set | | | Optional repetition of |
| | to | | | columns 1 through 4 |
| | is not | | | Optional repetition of |
| | | | | columns 1 through 4 |
| | is set to | | | Optional repetition of |
| | | | | columns 1 through 4 |
| | is less | | | Optional repetition of |
| | than or | | | columns 1 through 4 |
| | equal to | | | |
| | is less or | | | Optional repetition of |
| | equal to | | | columns 1 through 4 |
| | is less | | | Optional repetition of |
| | than | | | columns 1 through 4 |
| | is greater | | | Optional repetition of |
| | than or | | | columns 1 through 4 |
| | equal to | | | |
| | is greater | | | Optional repetition of |
| | or equal to | | | columns 1 through 4 |
| | is | | | Optional repetition of |
| | | | | columns 1 through 4 |
| | is (=) | | | Optional repetition of |
| | | | | columns 1 through 4 |
| | is less | | | Optional repetition of |
| | than or | | | columns 1 through 4 |
| | equal (<=) | | | |
| | is less | | | Optional repetition of |
| | than (<) | | | columns 1 through 4 |
| | is greater | | | Optional repetition of |
| | or equal | | | columns 1 through 4 |
| | (>=) | | | |
| | greater | | | Optional repetition of |
| | than (>) | | | columns 1 through 4 |
| | must be | | | Optional repetition of |
| | | | | columns 1 through 4 |
| | will be | | | Optional repetition of |
| | | | | columns 1 through 4 |
| | shall be | | | Optional repetition of |
| | | | | columns 1 through 4 |
| | not | | | Optional repetition of |
| | | | | columns 1 through 4 |
| “Expected | | | | Optional repetition of |
| Result” | | | | columns 1 through 4 |

Notes:
1. “Expected Result” is a fixed parameter name that is automatically created for every business rule and can be used in a require business rule to define the expected result from the optimized row test data.
2. “,” is treated as an “and”.
3. The Calcu function is any mathematical expression with the multiply (*), divide (\), add (+), subtract (−) and exponent (\hat{ }) operands. A parenthesis can be used to clarify a mathematical expression.

The Parameters and values used in the expression should be parameters which exist in the test data. The testing system allows this rule type to be entered in simple English prose or native language of the tester.
Examples of Require Business Rules, using the test data from step 1.

### Example 1

Condition: When ‘Operating System’ is Windows NT

Action: ‘Database’ is Oracle

Otherwise Action: ‘Database’ is Access

Result: In this example, if an optimized pair-wise row has Operating System as Windows NT, the Database is set to Oracle for that row. If an optimized pair-wise row does not have Operating System as Windows NT, the Database is set to Access for that row.)

### Example 2

Condition: When (‘Operating System’ is Windows NT and ‘RAM’ is >=256) or the ‘CPU’ is Pentium III

Action: ‘Database’ is Oracle, ‘CPU’ is set to Pentium IV

Otherwise Action: ‘Database’ is Access

Result: In this example, for every optimized pair-wise row that has Operating System as Windows NT and RAM that is greater or equal to 256, or the CPU is a Pentium III, then the Database is Oracle and the CPU is set to Pentium IV. If the condition is not true the Database is set to Access.

Examples of Require Business Rules, using the test data from table b.

### Example 1

Condition: When (‘Operating System’ is * or the ‘CPU’ is Pentium III

Action: ‘Database’ is Oracle, ‘CPU’ is set to Pentium IV

Otherwise Action: ‘Database’ is Access

Result: In this example, for every optimized pair-wise row no matter what the value of is or the CPU is a Pentium III, then the Database is Oracle and the CPU is set to Pentium IV. If the condition is not true the Database is set to Access.

### Example 2

Condition: If Calcu (Price * Value Factor)>=3000

Action: ‘Expected Results’ is Purchase this system configuration

Otherwise Action: ‘Expected Results’ is Do not purchase this system configuration

### Example 3

Condition: If Calcu (Price * Value Factor)>=Calcu (‘Maximum Funds’—Price)

Action: ‘Expected Results’ is Purchase this system configuration and Value Factor is >5

Otherwise Action: ‘Expected Results’ is Do not purchase this system configuration and Value Factor is <3

Result: Various combinations may be used and rules are not required to have an Otherwise. Each rule is stored in the database as a string and is associated with the raw test data for a particular test.

Step 3 (Data Rules): Apply Data Rules to the Test Data. Determine if there are any Data Rules. If there are, then apply them to the test data as described below. This result is a Modified Test Data set.

For Condition-Based Data rules, the algorithm parses each rule as described from left to right. A check is made to verify that a specified parameter name is defined. If the parameter is not defined in the test input, an error is displayed and processing terminates. If the parameter is not defined, processing proceeds and the value of the operand is checked. If the value is not valid, an error is displayed and processing terminates. If the value is valid, the value(s) associated with a parameter are checked to determine if they are present. After a data rule is parsed and has been legally defined, the data rule is applied against the input test data, row by row. When a parameter in the data rule is satisfied for each associated value in the data conditional expression, the data action is applied to that row. For Iteration-Based Data rules, the algorithm parses each rule as described from left to right. A check is made to verify that a specified parameter name is defined. If the parameter is not defined, an error is displayed and processing terminates. If the parameter is defined, processing proceeds and the value of the operand is checked. If the value is not valid, an error is displayed and processing terminates. If the value is valid, the value(s) associated with a parameter are checked to determine if they are present. After a data rule is parsed and has been legally defined, the data rule is applied against the input data, row by row. For a specified Parameter Name in the action, each row in that column is iterated from a starting value up to and including a maximum value by the specified increment.

Step 4 (Optimize): Determine the Dimensions of the Test Data (or Modified Test Data if Data Rules have been applied). The basis of for selecting the “best fit” orthogonal array is the maximum number of values (rows) and parameters (columns) in the test data. These dimensions are calculated by looping through the relational database where the test data resides. For non-symmetric test data, the number of values (rows) is the largest number of rows for all columns.

Step 5 (Optimize): Setup a Standard Set of Orthogonal Tables. Orthogonal arrays can be traced back to Euler's Graeco-Latin or magic squares but in Euler's time they were known as a type of mathematical game such as the problem of the 36 officers. The Thirty Six Officers Problem, posed by Euler in 1779, asks if it is possible to arrange 6 regiments consisting of 6 officers each of different ranks in a 6×6 square so that no rank or regiment will be repeated in any row or column. The idea of using orthogonal arrays for the design of experiments was studied independently in the United States and Japan during World War II to optimize the war effort. Although orthogonal arrays have been extensively used in the design of experiments, the use of them has been generally limited in the computer industry primarily for testing telecommunication networks. No existing process to date has been developed for extensive testing of computer applications and systems by orthogonalizing system parameters and values. The use of business rule constraints applied to the optimized test data using a rule-based engine are novel.

Orthogonal arrays are a standard construct used for statistical experiments with the notation:
OA(n,p,v)
where n is the number of experiments (test cases or configurations)
   p is the number of parameters in the experiment
   v is the number of values for each parameter

Standard Orthogonal arrays or Latin Squares are constructed and are denoted by L4, L9, L16, L25, L49, L64, L81, L121, L169, and L256. These correspond, respectively to 2, 3, 4, 5, 7, 8, 9, 11, 13 and 16 values per parameter. The basic orthogonal array for covering 2-way interactions is OA(v,v+1,v). In v test cases, up to v+1 parameters can be handled if there are v values for each parameter. An example of an orthogonal array used to generate the pair-wise test combinations with 4 parameters and 3 values is illustrated in table 1 below.

TABLE 1
OA(9, 4, 3) Orthogonal Array

| | |
|---|---|
| Configuration Number | Parameters |

| | | | | |
|---|---|---|---|---|
| 1 | 1 | 1 | 1 | 1 |
| 2 | 1 | 2 | 2 | 2 |
| 3 | 1 | 3 | 3 | 3 |
| 4 | 2 | 1 | 2 | 3 |
| 5 | 2 | 2 | 3 | 1 |
| 6 | 2 | 3 | 1 | 2 |
| 7 | 3 | 1 | 3 | 2 |
| 8 | 3 | 2 | 1 | 3 |
| 9 | 3 | 3 | 2 | 1 |

The number on the left column is called the experiment number (or test case number within the context of this invention), and for this example runs from 1 to 9. The vertical alignments are termed the columns of the orthogonal array, and every column consists of six each of the numerals 1, 2 and 3. Since combinations of the numerals of any column and those of any other column are made up of the numerals 1, 2 and 3, there are six possible combinations. When each of two columns consists of the numerals 1, 2 and 3, and the nine combinations (1,1), (1,2), (1,3), (2,1), (2,2), (2,3), (3,1), (3,2), and (3,3) appear with the same frequency, it is said that the two columns are balanced, or “orthogonal”. When there is a perfect symmetry or mapping between the input set and the orthogonal table, an exact pair-wise set of optimized data will be generated. This optimized test data set is considered “Orthogonal”. Orthogonal is not to be confused with Cartesian Products in which every unit of a group is matched with every unit of every other group. Orthogonal requires that if any two columns are selected, any combination (X, Y) should appear “the same number of times.” The present invention creates the set of standard orthogonal arrays and saves them into a common computer folder.

Step 6: (Optimize) Expand Each Standard Orthogonal Array. For each Standard orthogonal array, there are a fixed number of parameters (or columns) that can be handled. The present invention uses a process to expand a standard orthogonal array. This process expands each orthogonal array to handle up to 255 parameters (or columns). This step is required when the number of parameters is greater than the maximum number of values (plus one) for an Lx orthogonal array.

The first task for building an expanded orthogonal array is to define a proper subset of the original array. The notation for this subset, or RA is as follows:
RA( # of rows, # of columns, # times each column is repeated)
   Starting with a selected orthogonal array, certain columns and rows are eliminated to produce the proper subset. The first column to the left is dropped. The rows to be dropped are the ones with consecutive 1's, followed by consecutive 2's, and so on until a row with non-repeating consecutive numbers is observed.

For example, for an L4 there are 3 parameters and 2 values. Suppose it is desired to expand the number of parameters to 6 with 2 values each. The L4 array is shown below:

111
122
212
221

After the first column and first two rows are dropped, and the repeating sequence of consecutive numbers are dropped, the results are RA(2,2,1) as shown below:

| | |
|---|---|
| 12 | <-- proper subset |
| 21 | |

The justification for the proper subset is as follows. When extending a proper subset by duplicating the L array horizontally, there are columns that are duplicates. When these columns match up against each other, the (1,1), (2,2) . . . etc. combinations are all covered, but nothing else. The proper subset is a scheme to get the rest of the combinations covered, without again covering the (X, X) type of combinations.

A larger covering array is created from the proper subset array by first repeating the original L4 horizontally as shown below. The first column of the reduced array is placed below the first column of the orthogonal array repeatedly. Then, the second column of the proper subset is replaced below the second repeated orthogonal array. This process is continued until all the columns of the proper subset array have been placed as illustrated below.

| | |
|---|---|
| 111 111 | |
| 122 122 | <--- two copies of L4 |
| 212 212 | |
| 221 221 | |
| 111 222 | <--- the proper subset array, with duplicate columns |
| 222 111 | |

The entire grid is now a covering array for 6 parameters with 2 values each and there are 6 test configurations.

This process can be repeated to construct even larger subset arrays and is described as follows. The lower grouping is the RA(2,2,3), which is formed by taking RA(2,2,1) above, and repeating each column three times consecutively. The number of repetitions is exactly as wide as the group above it. The process is repeated again as follows:

| | |
|---|---|
| 111111 111111 | |
| 122122 122122 | |
| 212212 212212 | |
| 221221 221221 | <-- two copies of above array |
| 111222 111222 | |
| 222111 222111 | |
| 111111 222222 | <-- a wider proper subset array |
| 222222 111111 | |

The proper subset array is now RA(2,2,6); e.g. RA(2,2,1) with columns repeated six times. This is now a covering array for 12 parameters with 2 values each, comprising 8 test configurations.

The process can be continued until enough columns for the number of parameters of 255 is obtained. The number of “stages” required is based on the logarithm (base v) of the number of parameters. The reason the algorithm is quite different is that there is a distinction between an “orthogonal” array and a proper subset array. Since a proper subset array is less restrictive, the algorithm is not as complicated.

An optimized set of pair-wise tests can be used if the software yields only “True/False” conditions as in most software system testing. For real-valued test results, as most applications in other fields such as medicine and chemical engineering, orthogonal arrays are ideal for performing test data generation. The requirement for an orthogonal array is that if any two columns are selected, any combination (X,Y) should appear “the same number of times”. The “building block” approach for larger proper subset arrays can be used for other sizes of arrays using proper subset arrays.

Step 7: (Optimize): Decrypt the Expanded Orthogonal Tables. To optimize the modified test data, the Orthogonal Tables are decrypted from Orthogonal Tables that were previously encrypted for security reasons. A standard encryption/decryption algorithm is used to encrypt each orthogonal array into a text file. Each encrypted file is stored in a common folder.

Step 8: (Optimize): Input the “Best Fit” Orthogonal Array. The “best fit” orthogonal array needed is dependent on the maximum number of test values for any given parameter in a set of test data. If the number of values is less or equal to 16 for any parameter, the expanded orthogonal array can be used. These are the only tables that exist for useful purposes. The maximum restriction of 16 values can be solved by extending the orthogonal algorithm. Additionally, testing techniques can be applied such as equivalence class partitioning and boundary value analysis to reduce the number of values. For the missing number of values not in the standard orthogonal array sets, the next larger one is used. For example, for 6 parameters with 6 values for each parameter L49 is used.

Pair-wise coverage results in a number of test configurations that is proportional to the logarithm of the number of parameters, p and the square of the number of parameters values, v.

| | |
|---|---|
| Lower bound | Upper bound |
| 2 | 2 |
| [log (p)](v − v) + v | [log (p)](k − 1) + k |
| | where k is the next largest prime number >= v |
| v + 1 | k + 1 |

Table 2 below summaries the maximum number of parameters and values that can be accommodate by each L table. First column shows the orthogonal array type (L). The second and third column is the number of parameters and values, respectively. The fourth column is the number of orthogonal tests required. The fifth is the number of required tests for theoretical test combinations. It is calculated by multiplying the total number of rows in the test data set by each column. The comparison of column 4 and 5 illustrates the dramatic reduction in the number of tests using orthogonal arrays.

TABLE 2
Standard Orthogonal Arrays versus Number of Tests

| Orthogonal | Number of | Number of | Number of | Number of |
|---|---|---|---|---|
| Table | Parameters | Values | Orthogonal | Theoretical Test |
| (L Notation) | (columns) | (rows) | Tests | Combinations |
| L4 | 3 | 2 | 4 | 8 |
| L9 | 4 | 3 | 9 | 81 |
| L16 | 5 | 4 | 16 | 1,024 |
| L25 | 6 | 5 | 25 | 15,625 |
| L49 | 8 | 7 | 49 | 5,764,801 |
| L64 | 9 | 8 | 64 | 134,217,728 |
| L81 | 10 | 9 | 81 | 3,486,784,401 |
| L121 | 12 | 11 | 121 | 3.1384E+12 |
| L169 | 14 | 13 | 169 | 3.9374E+15 |
| L256 | 17 | 16 | 256 | 2.9515E+20 |

Step 9 (Optimize): Decrypt the “Best Fit” Orthogonal Array. Once the “best fit” orthogonal array has been determined based upon Table 2, the orthogonal test file is input into memory row by row and decrypted using the same encryption/decryption algorithm (such as “blowfish” or “Huffman) are was used to encrypt each orthogonal text file previously. This step is only required if the original file was encrypted.

Step 10 (Optimize): Generate Pair-Wise Optimized Input Test Data. To pair-wise optimize the input test data the present invention goes through each element in the input test data and is mapped by each element in the “best fit” orthogonal table to the optimum pairs. To illustrate this mapping process, consider the problem of testing software on several different PC configurations. Table 3 shows four parameters that define a very simple test model. The Operating System parameter defines the type OS the application is running on. Its values are Windows NT, Windows 2000 and Windows XP. The RAM parameter defines how much RAM is running on the PC. Its values are 256MB, 512MB, and 1Gig. The CPU Speed parameter defines the processor type. The CPU Speed values are Pentium II, Pentium III, and Pentium 4. The final parameter, Database, is the database that the software will be running against.

TABLE 3
Interoperability Test Parameters and Values

| Operating System | RAM | | CPU Speed | Database |
|---|---|---|---|---|
| Windows NT | 256 | MB | Pentium II | Oracle |
| Windows 2000 | 512 | MB | Pentium III | SQL |
| Windows XP | 1 | Gig | Pentium 4 | Access |

Since each different operation of parameter values determines a different test scenario, and each of the four parameters has three values, this configuration defines a total of 3×3×3×3 scenarios. The present invention significantly reduces the number of tests to generate test cases to cover every pair-wise combination of parameter values. The “best fit” array in this example is L9 that will handle 4 parameters (columns) and 3 values (rows). The L9 orthogonal array is shown in Table 4 below.

TABLE 4
L9 Orthogonal Array
Mapping

| | | | |
|---|---|---|---|
| 1 | 1 | 1 | 1 |
| 1 | 2 | 2 | 2 |
| 1 | 3 | 3 | 3 |
| 2 | 1 | 2 | 3 |
| 2 | 2 | 3 | 1 |
| 2 | 3 | 1 | 2 |
| 3 | 1 | 3 | 2 |
| 3 | 2 | 1 | 3 |
| 3 | 3 | 2 | 1 |

The present invention maps the test data row by row using the L9 orthogonal array. The first row of the orthogonal array is 1, 1, 1, 1. The first row of the pair-wise optimized test set is created using these values. For example, the first 1 of the 1, 1, 1, 1 set is used to determine the first element in the pair-wise test cases, e.g. Windows NT. The subsequent first row values ate 256MB, Pentium II and Oracle.

TABLE 5
Pair-wise Test Cases for the first row

| | Operating | | | |
|---|---|---|---|---|
| Test Case | System | RAM | CPU Speed | Database |
| 1 | Windows NT | 256 MB | Pentium II | Oracle |

This process continues until the complete pair-wise test data set is created. Table 6 below shows the 9 pair-wise test cases as opposed to 81.

TABLE 6
Optimized Test Cases

| Test Case | Operating System | RAM | | CPU Speed | Database |
|---|---|---|---|---|---|
| 1 | Windows NT | 256 | MB | Pentium II | Oracle |
| 2 | Windows NT | 512 | MB | Pentium III | SQL |
| 3 | Windows NT | 1 | Gig | Pentium 4 | Access |
| 4 | Windows 2000 | 256 | MB | Pentium III | Access |
| 5 | Windows 2000 | 512 | MB | Pentium 4 | Oracle |
| 6 | Windows 2000 | 1 | Gig | Pentium II | SQL |
| 7 | Windows XP | 256 | MB | Pentium 4 | SQL |
| 8 | Windows XP | 512 | MB | Pentium II | Access |
| 9 | Windows XP | 1 | Gig | Pentium III | Oracle |

When the parameters don't have the same number of values, the array is based on the largest number of values. For parameters with fewer than the maximum number of values, non-existent values can be considered “don't care” or “-”. For example, consider a modified version of the test data in Table 3 as shown in Table 7 below:

TABLE 7
Modified Interoperability Test Parameters and Values

| Operating | | | | |
|---|---|---|---|---|
| System | RAM | | CPU Speed | Database |
| Windows NT | 256 | MB | Pentium II | Oracle |
| Windows 2000 | 512 | MB | Pentium III | SQL |
| | 1 | Gig | | Access |

For this case the L9 orthogonal array can still be used, as for the overall table, there are 4 parameters (columns) and 3 values (rows). The difference is that there are missing 3rd values for the Operating System and CPU Speed parameters. The mapping of the L9 orthogonal array is as follows:

TABLE 8
L9 Array and Mapped L9 Array

| | |
|---|---|
| L9 Array | Mapping |

| | | | | | | | |
|---|---|---|---|---|---|---|---|
| 1 | 1 | 1 | 1 | 1 | 1 | 1 | 1 |
| 1 | 2 | 2 | 2 | 1 | 2 | 2 | 2 |
| 1 | 3 | 3 | 3 | 1 | — | 3 | 3 |
| 2 | 1 | 2 | 3 | 2 | 1 | 2 | 3 |
| 2 | 2 | 3 | 1 | 2 | 2 | — | 1 |
| 2 | 3 | 1 | 2 | 2 | 3 | 1 | 2 |
| 3 | 1 | 3 | 2 | — | 1 | — | 2 |
| 3 | 2 | 1 | 3 | — | 2 | 1 | 3 |
| 3 | 3 | 2 | 1 | — | 3 | 2 | 1 |

The interpretation of the ‘-’, e.g. “don't care” value is that any other parameter value can used where there does not exist a respective value in the input data set. For example, in the third row of Table 8 there is a “-” (don't care value) because there does not exist a respective value in the input data set. The present invention selects one value from the rest of the parameter values by using the first value for the parameter and proceeding to the next value until the data is symmetric. Thus, for the Operating System parameter, Windows NT or Windows 2000 would be selected. If a fourth row were present, Windows 2000 would be selected next, and so forth.

The present invention also assures there are no duplicates that can occur because of non-symmetrical input test data sets. This is accomplished as follows: the orthogonal process to create pair-wise tests proceeds row by row. Each element in an optimized row is concatenated to produce a string. This string is passed to a “collection object” to determine if the row has been used previously. If so, the row is deleted during the optimization process.

For a larger example, such as an input test set of 255 parameters and 16 values, there are 16 possible parameter combinations. In this example, the present invention only requires 496 test cases. It is known that in most systems, the relative complexity and number of variables precludes testing all the combinations. Pair-wise combinations allows the generation of a small subset of combinations that insures that at least all the pair-wise combinations have been exercised.

Step 11 (Business Rules): Constrain the Optimized Pair-wise Test Data with Business Rules. The present invention creates pair-wise optimized test set from the input Test Data or Modified Test Data (if Data Rules have been applied). Business rules are then applied to the optimized test data to constrain the test data to reflect the behavior of the system or application under test. There are two types of business rules (or constraints): Exclude and Require. An exclude business rule is a condition. Each exclude business rule condition is tested against each row of the optimized test data and will remove that row when one or more exclude rules are true within the pair-wise optimized test set. After processing the exclude business rules each require business rule (or constraint) is tested against each row of the optimized test set. For each row, zero, one or more values in the optimized test set will be modified if the condition is true using the action (true condition) or otherwise (false condition, if present).

For each exclude or business rule, the present invention first initializes the final evaluation string as a null value, e.g. “”. The present invention then parses each rule looking first for “if”, “when” or “whenever”. If one of these prefix conditions is not present an error is displayed. If there is no error, the syntax parser stores the source and target parameters into a 2-dimensional internal array. The first column of the array is the Source Parameter and the second is the Target value or parameter. Before storing, the parameter is verified. If it is invalid (not in the input test data column header) an error message is displayed.

Next, the operator is also verified. If one of the value operators is not present, an error message is displayed. The parser then determines if the current condition is a compound condition and looks for “(“, ”)”, “and”, “or”. If a value operator is found, the final result string is concatenated with the source parameter, operator and target value, parameter or compound operator. While parsing the source and target parameters or values, each is stored in a 2-dimensional internal array which will be used later when evaluating the conditional string against each row in the optimized test data set.

The parsing process continues until the complete condition has been parsed and the final evaluation string variable has been created. If any error occurs during parsing an error message is displayed. For exclude business rules, all the conditions are concatenated with an “or” operator to separate each into one final evaluation string. This string is then applied to each row in the optimized test data set. If the condition for a row is “True” then row is deleted. If not, the row is not deleted.

For Require business rules, the same parsing rules are applied to the condition, however, there also is an Action and optional Otherwise rule which is parsed. The parsing rule for “Action” or “Otherwise” are similar to condition parsing with the following exception:
(1) Expressions cannot have any “or” operators.
(2) Expressions can only have “and” reflecting multiple actions to be performed
(3) The action(s) are stored in another 1-dimenstional internal array for later usage.
   For each business rule being parsed the “Action” and “Otherwise” actions are stored in another 2-dimensional internal array. The first index position contains the “Action” actions and the second contains the “Otherwise” actions.

Once all business rules have been parsed, each parsed rule is evaluated against each row in the optimized test data set using an “Eval” statement which generates either a “True” or “False” state. If the state for a row is “True” then actions stored in the first index of a 2-dimensional internal array are used to modify the optimized test data values. If the state for a row is “False”, the “Otherwise” actions located in the second index of the 2-dimensional internal array are used to modify the optimized test data values.

The method also assures there are no duplicates that can occur because of the data values being modified. This is accomplished as follows: the element results of applying each business rule to each row is concatenated into a string which is first initialized to a null value, e.g. “”. This string is passed to a “collection object” to determine if the row has been used previously. If so, the row is deleted during the optimization process.

Once the test data has been optimized and all business rules (if any) applied, the resulting final optimized test case data set is written to a table in the database. For example, the present invention permits the tester to store the test data in an ACCESS® database or the like, such as SQL®, Sybase®, Oracle®, via ODBC technology. Moreover, the results of the tests can be seamlessly exported to an Excel® spreadsheet which can be used by automated capture/playback testing tools. These results are then displayed to the user via a grid in the Graphical User Interface. The software tester can then view the resulting test set for a particular set of raw test data and rules.

Step 12 (Matrix) The method also creates a Business Rules Versus Test Case Matrix to document which test cases in the final optimized test set are associated with each business rule. This is handled with the use of a 2-dimensional internal array. The horizontal plane is a list of the business rules. The vertical plane is the test case number generated during the pair-wise optimization and business rules constraining process. Every business rule will have an “x” or “?” intersection for at least one test case. A cell intersection will have an “x” when each rule and condition with the rule is true and false based upon the input data values, otherwise it will have a “?”. When a “?” is displayed in the intersecting cell, the user can right-mouse to display the business rule with the test data in question highlighted. The user will be prompted to either enter the test value manually or can optionally let the program create the test data. The above guarantees branch/condition and boundary value coverage of the business rules. The value of this is the fact that most software defects are uncovered when both positive and negative test conditions are tested.

In the example below branch/condition and boundary value testing is satisfied when the following test cases are executed:

| Test Case | | | | Value | Expected |
|---|---|---|---|---|---|
| Number | CPU | RAM | Database | Factor | Result |
| 1 | Pentium III | 256 | Oracle | 5 | 3500 |
| 2 | Pentium IV | 255 | Access | 3 | 2000 |
| 3 | Pentium III | 255 | Oracle | 4 | 1500 |
| 4 | Pentium II | 257 | Access | 6 | 2000 |
| 5 | Pentium II | 128 | Access | 3 | 0 |

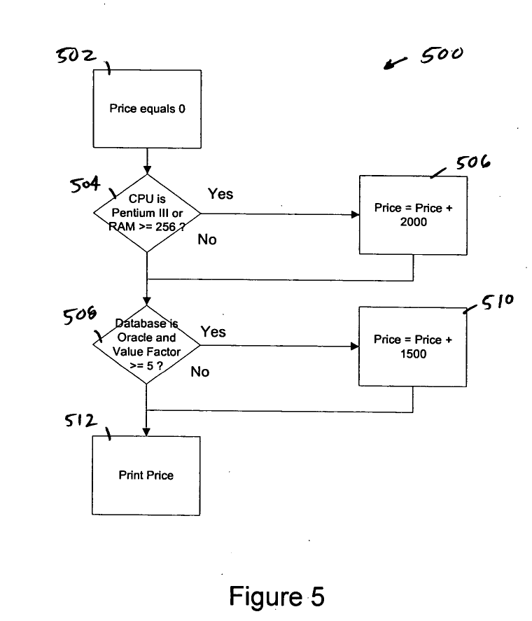

FIG. 5 is a flow diagram 500 of an example in accordance of one embodiment of the present invention. The price equals 0 in block 502. If the CPU is a Pentium III or the RAM is greater than or equal to 256, as determined in decision block 504, the price equals price plus 2000 in block 506. After the price is adjusted in block 506, or if the CPU is not a Pentium III and the RAM is less than 256, as determined in decision block 504, the database and value factor are checked in decision block 508. Specifically, if the database is Oracle and the value factor is greater than or equal to 5, as determined in decision block 508, the price equals price plus 1500 in block 510. After the prices is adjusted in block 510 or if the database is not Oracle or the value factor is less than 5, as determined in decision block 508, the price is printed in block 512.

This invention assures that there is at least one data value to cover the positive and negative cases for each condition rule. During the syntax verification for a simple of complex conditional expression the parameter name, operand and value is parsed. Based upon the operator type the input test data for a parameter is searched to verify that every condition value will test a true and false value. For example, if the operand is an “equals”, the parameter is searched to assure the value represented in the conditional expression exists. It is also verified that a value other than the one specified in the conditional expression exists. If there exists data values for the value specified in the conditional expression and there is another different value, an asterisk (*) will be placed in the Business Rule Versus Test Case matrix for that a particular rule. If there is not a true and false data value then a question mark (?) will be placed in the Business Rule Versus Test Case Matrix. This indicates to the user that a particular business rule does not have all the data values needed to assure that each decision point is traversed as true and false and that every condition within a decision has data values to cover the true and false condition. This matrix is “global” and is displayed in the Business Rule Versus Test Cases grid in the tree view when control is returned. After returning to the tree user interface, if the user selects a business rule from the Business Rule Versus Test Cases grid (right-mouse) the respective business rule is displayed enabling the user to determine the data test value(s) that is missing If the user selects a test case, the test case row is displayed in the tree view.

Input test data, Business Rules, data rules and the Final Test set are uniquely identified in the database as belonging to a particular test. This allows an almost unlimited amount of tests to be stored in the database. These tests are managed with a tree structure in the Graphical User Interface of this testing system. The tree consists of the following levels: Root Level, Enterprise Level, Project Level, Role Level, Group Level and Test level. Below is the structure of the tree and how it can be organized:

```
−SmartTest
    +Enterprise1
        +Project1
            +Role1
                +Group1
                    −Test1
                    −Test2
                    −Test(n)
                +Group2
                    −Test1
                    −Test2
                    −Test(n)
        +Project2
            +Role1
                −Test1
                −Test2
                −Test(n)
            +Role2
                −Test1
                −Test2
        +Project3
            −Test1
            −Test2
            −Test(n)
```

When a particular test is selected from the tree, four tabs representing different tables in the database are displayed: Input, Rules, Results, and Matrix

While the present invention has been described in terms of the preferred embodiment, those skilled in the art would understand that the invention could be modified from the preferred embodiment but still operate within the breadth and scope of the invention as described herein.

What is claimed is:

1. A method for generating a final optimized test data set comprising the steps of:
providing an initial test data set, one or more data rules and one or more business rules;
modifying the initial test data set using the one or more data rules;
optimizing the modified test data set using an orthogonal array;
generating the final optimized test data set by applying the one or more business rules to the optimized test data set.

2. The method as recited in claim 1, wherein the initial test data set comprises a set of parameters and values.

3. The method as recited in claim 1, wherein the initial test data set is derived from fields and values from a graphical user interface, parts of a network, a system configuration, one or more functional items, a functional specification or an application interface.

4. The method as recited in claim 1, further comprising the step of determining whether the initial test data set is sufficient.

5. The method as recited in claim 1, wherein the one or more data rules define the behavior of the data within the initial test data set.

6. The method as recited in claim 1, wherein the one or more business rules define the behavior of the application or system to be tested.

7. The method as recited in claim 1, wherein the one or more data rules or the one or more business rules are entered in a simple prose format.

8. The method as recited in claim 1, wherein the modified test data set is optimized by generating a set of pair-wise values using the orthogonal array.

9. The method as recited in claim 1, wherein the set of pair-wise values allow a smaller subset of test case data while providing a statistically valid means of testing all independent component state transitions.

10. The method as recited in claim 1, wherein the orthogonal array is a “best fit” orthogonal array selected from the group of orthogonal Latin squares designated L4, L9, L16, L25, L49, L64, L81, L121, L169 and L256.

11. The method as recited in claim 1, further comprising the step of setting up a standard set of orthogonal tables.

12. The method as recited in claim 1, further comprising the step of expanding the orthogonal array.

13. The method as recited in claim 12, further comprising the steps of:
encrypting the expanded orthogonal array into a text file; and
decrypting the text file.

14. The method as recited in claim 1, further comprising the step of applying the one or more business rules to the optimized test data set to create a final test case data set.

15. The method as recited in claim 14, further comprising the step of creating a matrix of the final test case set versus the one or more business rules.

16. The method as recited in claim 15, wherein the matrix indicates whether one or more positive and one or more negative test conditions are covered by the final test case set.

17. The method as recited in claim 1, further comprising the step of storing the final test case data set in a relational database.

18. The method as recited in claim 17, further comprising the step of exporting the set of final test case data to a data file.

19. The method as recited in claim 18, further comprising the step of importing the final set of case data into an automated capture/replay testing tool.

20. The method as recited in claim 1, wherein the one or more data rules comprise one or more condition based rules or one or more iteration based rules.

21. The method as recited in claim 1, wherein the one or more business rules comprise one or more exclude statements or one or more require statements.

22. An optimized test data set generated in accordance with the method of claim 1.

23. A method for generating a final optimized test data set comprising the steps of:
providing an initial test data set;
modifying the initial test data set using a first set of constraints;
optimizing the modified test data set using an orthogonal array;
generating the final optimized test data set by applying a second set of constraints to the optimized test data set.

24. The method as recited in claim 23, wherein the first set of constraints comprise one or more data rules.

25. The method as recited in claim 24, wherein the second set of constraints comprise one or more business rules.

26. An optimized test data set generated in accordance with the method of claim 23.

27. A computer program embodied on a computer readable medium for generating a final optimized test data set comprising:
a code segment for providing an initial test data set, one or more data rules and one or more business rules;
a code segment for modifying the initial test data set using the one or more data rules;
a code segment for optimizing the modified test data set using an orthogonal array;
a code segment for generating the final optimized test data set by applying the one or more business rules to the optimized test data set.

28. A computer program for generating a final optimized test data set comprising:
a code segment for providing an initial test data set;
a code segment for modifying the initial test data set using a first set of constraints;
a code segment for optimizing the modified test data set using an orthogonal array;
a code segment for generating the final optimized test data set by applying a second set of constraints to the optimized test data set.

29. The computer program as recited in claim 28, wherein the computer program is a plug in.

30. The computer program as recited in claim 28, wherein the computer program is a part of a developer's tool kit.

31. An system comprising:
a data storage device having an initial test data set, one or more data rules and one or more business rules stored therein;
a processor communicably coupled to the data storage device that modifies the initial test data set using the one or more data rules, optimizes the modified test data set using an orthogonal array and generates the final optimized test data set by applying the one or more business rules to the optimized test data; and
one or more input/output devices communicably coupled to the processor.
